(19) United States
(12) Patent Application Publication
(10) Pub. No.: US 2026/0308283 A1
(43) Pub. Date: Oct. 8, 2026

(54) HIGHLY SOLUBLE PEA STARCH AS REPLACER OF MALTODEXTRIN

(71) Applicant: ROQUETTE FRERES, Lestrem (FR)

(72) Inventors: Rongzhu CHENG, Geneva, IL (US); Liuning ZHOU, Geneva, IL (US); Cameron POMBERT, Geneva, IL (US)

(21) Appl. No.: 19/482,121

(22) PCT Filed: May 7, 2024
(86) PCT No.: PCT/EP2024/025158

§ 371 Date: Nov. 6, 2025

Related U.S. Application Data
(60) Provisional application No. 63/464,666, filed on May 8, 2023.
(60) Provisional application No. 63/538,546, filed on Sep. 15, 2023.

(51) Int. Cl. C08B 30/14; A21D 2/18; A23L 2/52; A23L 27/00; A23L 27/60; A23L 29/212

(52) U.S. Cl. CPC C08B 30/14; A21D 2/186; A23L 2/52; A23L 27/60; A23L 27/72; A23L 29/212

(57) ABSTRACT

The invention is related to a high soluble leguminous starch having a content of oligosaccharides with a Degree of Polymerization (DP) of 1 and 2 of less than 10% in weight, more preferably less than 6%, a content of oligosaccharides with a DP of 3 to 20 of more than 50% in weight, more preferably more than 70%, a water solubility of more than 90% in weight, more preferably more than 95%, a viscosity of less than 500 cP, more preferably of less than 100 cP, and characterized by an α 1,4/α 1,6 ratio determined by ¹³C NMR between 23 to 32%.

The present invention deals with a highly soluble leguminous starch produced by physical means (clean process), i.e. without addition of any chemicals or enzymes, and its use as maltodextrin alternative for bakery, sauce and dressing, dairy and beverage, more specifically for flavor encapsulation. More preferably, this leguminous starch is pea starch.

Hence, the present invention concerns a process that consists essentially in cooking starch-water mixture in particular conditions.

### STATE OF THE ART

Starch is undeniably the most important polysaccharide in the human diet. It is only second to cellulose in terms of abundance of organic compounds in the biosphere.

The attractiveness of starch usage in the food and non-food industries could be ascribed to its cheapness, abundance, biodegradability and non-toxic nature. Starches are easily obtained from various botanical sources, e.g., cereal, legume, root and tuber and green fruit.

The need for native starch modification is due to the inherent deficiencies in its properties.

Native starches are insoluble in water, easily retrograde with associated syneresis and most significantly gels and pastes produced by native starches are unstable at high temperature, pH and mechanical stress.

Due to these inherent native starch inadequacies, there is need for modification to better the functional and physicochemical properties for suitable industrial applications.

Modification of starches can be broadly divided into physical, chemical, biotechnological and enzymatic ways or their combinations properly called dual modification.

Amongst them, physical methods are more acceptable since they are general chemical-free and hence considered safer for human consumption.

Physical modification of starch is more connected to the emerging concept of “clean label”, “green technology” or “sustainable technology” for environmentally friendly applications.

Indeed, consumers are demanding more transparency about the ingredients in their foods, driving increased interest in ingredients that meet “clean label” guidelines.

Clean labeling could be any one or more of the following:
Recognizable ingredients
Minimal ingredients
Minimally processed
No artificial ingredients
No preservatives
Non-GMO
All-natural
Organic
Country of origin

Physical modification of starch can improve water solubility and reduce particle size. The methods involve the treatment of starch granules under different temperature/moisture combinations, pressure, shear and irradiation.

Physical modification also includes mechanical attrition to change the particle size of starch granules.

Physical modification techniques are generally given preference as they do not involve any chemical treatment that can be harmful for human use.

The broad classification of starch physical modification into those that are thermal and others that is non-thermal.

The thermal processes involve:
The ones in which the starch granule structures are destroyed (all pre-gelatinization processes), and
The ones in which the granules are preserved (hydrothermal processes: annealing and heat-moisture treatment).

In pre-gelatinization, the granular structure of starch is totally destroyed as a result of heating, there is de-polymerization and fragmentation and so the molecular integrity of the starch is not preserved.

Therefore, pre-gelatinized starches are starches that have undergo gelatinization and consequently are depolymerized, fragmented and the granular structure is entirely destroyed as a result of cooking. The pre-gelatinization process is achieved by drum drying, spray drying and extrusion cooking. The properties associated with pre-gelatinized starches permits instant dissolution in cold water without heating.

Due to the harsh treatment (gelatinization and severe drying) used to obtain pre-gelatinized starches, it is porous, possessed higher water absorption index and water solubility index than that of the native starches.

However, there are certain limitations associated with pre-gelatinized starches which have reduced its applications in certain foods.

These include grainy texture, inconsistent and weak gels. These demerits have been surmounted by the development of granular cold water swelling starch. The latter can exhibit cold water thickening despite keeping its granular integrity, it possesses higher viscosity, more homogeneous texture with higher clarity and has more processing tolerance than pre-gelatinized starches.

Unlike native starch, they can rapidly absorb water and increase their viscosity at ambient temperature. This useful functionality has made them applicable in a range of products synthesized at low temperature containing heat-labile components (e.g., vitamins and coloring agents) and instant food.

Undeniably, the functional and physicochemical properties of various modified starches determine their applications in the food industry.

Unlike pre-gelatinization, annealing and heat-moisture treatment involve heating starch in water at a temperature below the gelatinization temperature (GT) and above the glass transition temperature (Tg). Consequentially, the granular structure of starch is preserved.

Modification of starch is an ever evolving industry with numerous possibilities to generate novel starches which includes new functional and value added properties as demanded by the industry.

In the field of the present invention, the applicants were more particularly interested in the preparation and the use in food applications of maltodextrins.

Maltodextrins are polymers of saccharides that consist of glucose units, primarily linked by α-1,4 glucosidic bounds. These starch derivatives are commonly prepared from corn, rice, potato starch or wheat. Even though they come from plants, they are highly processed.

Maltodextrins are indeed classically obtained from enzymatic hydrolysis with or without acid but to a lower extent than that required to produce starch syrups.

Maltodextrins are available in different molecular weights as dextrose equivalent (DE) according to the production method and source. The DE is expressed as a percentage of glucosidic-bound hydrolysis, showing their reducing power.

Maltodextrins provide good oxidative stability to oil encapsulation but exhibit poor emulsifying capacity, emulsion stability and low oil retention. Maltodextrins with 10 to 20 DE fit in for use as coating materials and show the highest retention of flavor. Moreover, maltodextrins are a good compromise between cost and effectiveness, bland in flavor, have low viscosity at high solids ratio, and aqueous solubility, resulting in their interest, value for encapsulation. Therefore, maltodextrin is a versatile ingredient in food industrial and has large application in food industries including food and beverage, sauce and dressing, bakery, dairy, flavor encapsulation . . . .

However, it is not consumer and Consumer Packaged Goods (CPG) friendly for due to clean label concerns. Indeed, to increase the solubility, classical ways to hydrolyze starch needs acid and/or enzymes to chemically decompose the long chains of starch molecules. The problems associated with those technologies include:
1. Add foreign components into natural materials,
2. High operational costs caused by adding and then removing the foreign components,
3. Additional capital costs for the adding and removing steps.

For that reason, a certain number of alternatives have been developed to produce starch derivatives having functionalities (as solubility) similar to maltodextrin that will have high market potential based on Customer feedback and Marketing strategy.

However, if various commercial products exist like cold-water soluble starch or pre-gelatinized starches, their solubility is often much lower than maltodextrin and therefore cannot substitute the use of maltodextrin.

Therefore, to respect the wishes of the consumers, there is a need in the corresponding field to offer a “clean label” solution.

The Applicant found that the solution goes through the to use physical means for starch hydrolysis, to eliminate the addition of chemical/enzyme, to generate clean label soluble starch, and to meet the customers' demands and market trend on green products.

However, it does not exist in the state of the art very efficient technical alternative way to produce maltodextrin-like products.

The most commonly applied thermal treatment is that used to make pregelatinized starches. As already discussed, these starches have been completely cooked, i.e., pasted, and dried under conditions that allow little or no molecular reassociation. They are described as being cold-water soluble, although many such products will develop additional viscosity upon heating aqueous dispersions of them. Nevertheless, even if the resulting pregelatinized starches are more soluble, this solubility is low, usually less than 50%, far from that of maltodextrins.

Depolymerisation also occurs during the pregelatinisation processes. The molecular weights of starch amylose and amylopectine usually decrease by factors 1.5 and 2.5 respectively. However, this thermal process needs high temperature treatment (>140° C. during 2 to 12 hours) and the heated starch solution obtained contains high concentration of compounds presenting a low degree of polymerization (DP) content (DP<6).

Physical non-thermal processes have been developed in that perspective: microwave, milling or sonication directly on native starch.

However, the heating of aqueous slurry of starch granules using microwaves is difficult to implement on an industrial scale.

The milling mechanically reduces particle sizes of starch granules to less than 20 micrometers, but it is very energy-intensive consumption. Furthermore, it is not possible to achieve the desired solubility.

Therefore, there is still a very strong interest in seeking new processing methods for producing alternatives to maltodextrin.

### SUMMARY OF THE INVENTION

The present invention relates to a highly soluble leguminous starch having:
A content of oligosaccharides with a Degree of Polymerization (DP) of 1 and 2 of less than 10% in weight, preferably of less than 7% in weight, preferably of less than 6% in weight,
A content of oligosaccharides with a DP of 3 to 20 of between 30% and 40% in weight,
A water solubility of more than 95% in weight, more preferably more than 98% in weight,
A viscosity of less than 500 cP, more preferably of less than 200 cP
and characterized by:
An α-1,4/α-1,6 ratio determined by ¹³C NMR between 23 to 32%.

The present invention is also relative to a process for preparing a highly soluble starch comprising, more preferably consisting in the following steps:
Preparation of a starch slurry,
Gelatinization of the starch slurry,
Cooking of the gelatinized starch,
Refining of the thermal decomposed solution such obtained with active carbon, filtration and evaporation, and
drying of the concentrated solution to obtain a powder product.

The invention also concerns the use of the highly soluble leguminous starch of the invention in food applications as an alternative to maltodextrin.

The invention concerns also its use as alternative to maltodextrin for the preparation of bakery, sauce and dressing, dairy and beverage, more specifically for flavor encapsulation (as carrier for flavor encapsulation) but also for the preparation of fat free vinaigrette or the preparation of powder beverage formulation such as tropical punch mix or energy beverage.

### DETAILED DESCRIPTION OF THE INVENTION

The invention relates to a highly soluble leguminous starch having:
A content of oligosaccharides with a Degree of Polymerization (DP) of 1 and 2 of less than 10% in weight, preferably of less than 7% in weight, preferably of less than 6% in weight,
A content of oligosaccharides with a DP of 3 to 20 of between 30% and 40% in weight,
A water solubility of more than 95% in weight, more preferably more than 98% in weight,
A viscosity of less than 500 cP, more preferably of less than 200 cP and characterized by:
An α-1,4/α-1,6 ratio determined by ¹³C NMR between 23 to 32%

According to the invention, said leguminous starch has an amylose content ranging between 25 and 60 percent by weight (dry/dry) and can be embodied as pea starch, especially pea starch having an amylose content of at least 30 percent but less than 50 percent by weight.

With such a profile (which, to the Applicant's knowledge, has never been described), the high soluble starch or highly soluble starch according to the invention has a functional profile equivalent to maltodextrin (in terms of DP content, solubility, viscosity), but a structure nearly identical to that of the native starch (in terms of α 1,4/α 1,6 ratio), from which it is prepared.

This could notably also be proven by the fact that the highly soluble starch according to the invention is blue in the starch iodine-test whereas, as the man skilled in the art knowns, conventional maltodextrin is typically brown.

The measure of the content of oligosaccharides with a Degree of Polymerization (DP) of 1 and 2; and of 3 to 20; is typically determined by the industrial standard carbohydrates analysis method.

Thus, high pressure liquid chromatograph with ion-exchange resin in silverform, AMINEX HPX—42A resin, was employed. Area at certain retention time corresponding to an individual DP value was recorded; the percentage of that particular DP was calculated as:

$$\% DP = Individual DP Area / Summation of all DP Areas$$

The high soluble pea starch has a content of oligosaccharides with a Degree of Polymerization (DP) of 1 and 2 of less than 7% in weight, more preferably less than 5%, and a content of oligosaccharides with a DP of 3 to 20 of between 30% and 40% in weight, more preferably between 30 to 35%.

By comparison, the maltodextrin GLUCIDEX® 12 commercialized by the Applicant has a content of oligosaccharides of DP1 and DP2 of about 3% and a content of oligosaccharides with a DP of 3 to 20 of about 44%.

The expression “content of oligosaccharides of DP1 and DP2” refers to the total of the % in weight of oligosaccharides of DP1 and oligosaccharides of DP2.

In an embodiment, the high soluble pea starch according to the invention has Degree of Polymerization (DP) of 1 and 2 of at least 4%, or preferably of at last 4.5%.

In an embodiment, the high soluble pea starch according to the invention has Degree of Polymerization (DP) of 1 and 2 of between 4% and 7%, preferably of between 4% and 6%, preferably of between 4% and 5%.

Solubility can be determined by any methods for determining solubility. Such methods are well known to the person skilled in the art. The solubility has been determined by the method given in the Example 1.

The high solubility pea starch presents a water solubility of more than 95% in weight, more preferably more than 98% in weight.

By comparison, the maltodextrin GLUCIDEX® 12 presents a water solubility of more of about 93%.

The viscosity is a Brookfield viscosity, preferably a Brookfield viscosity measured at 15° C. degrees centigrade. The viscosity is preferably measure on a dispersion at a starch concentration of 45% w/w. The viscosity has been measured by the method given in the Example 1.

The procedure is the following:
Dissolve the sample to be tested in deionized water at room temperature to form a solution at a concentration of 45% w/w;
viscosity is measured with Brookfield II viscometer using #21 spindle, at a temperature of 15° C. following the manufacturer's specifications;
temperature was controlled with circulated water bath.

The high solubility pea starch presents a viscosity of less than 200 cP, more preferably of less than 100 cP.

By comparison, the maltodextrin GLUCIDEX® 12 presents a viscosity of less about 600 cP.

By comparison, the native pea starch N735 commercialized by the Applicant presents a viscosity of 20 cP.

Preferably, the high solubility pea starch presents a viscosity of more than 30 cp, preferably more than 40 cP.

Preferably, the high solubility pea starch presents a viscosity of between 30 cP and 700 cP, preferably of between 40 cP and 600 cP, preferably of between 40 cP and 500 cp.

However, if the high soluble pea starch of the invention presents all these properties in common with maltodextrines, it is definitively not a maltodextrin.

Indeed, the high soluble pea starch of the invention has preserved natural form/structure of native pea starch, while conventional maltodextrin has different starch structure.

It can be illustrated by the α 1,4/α 1,6 ratio of the macromolecule, determined by NMR ¹³C.

The NMR ¹³C methodology followed is based on the work of:
Gidley, Michael J. (1985) in Carbohydrate Research, 139, 85-93.
Schmitz, Sarah. (2009) in Macromolecular Bioscience, 9, 506-514
Tizzotti, Morgan J. (2011). Journal of Agricultural and Food Chemistry, 59, 13, 6913-6919.

The procedure is the following:
1. Weight 10±0.05 mg starch sample.
2. Add 1.0 mL of anhydrous DMSO-d6 contained 0.5% (w/w) LiBr to the sample.
3. Add a tiny stir bar into the mixture and incubate the sample overnight at 80° C. and 300 rpm.
4. Cool the sample to room temperature.
5. Add 0.5 mL of sample mixture to the NMR tube.
6. Add 5.66 μL of deuterated trifluoroacetic acid (d1-TFA) to the medium just before the NMR measurement.
7. Analyze the sample with 1 H NMR, obtain the 1 H NMR spectra at 70° C.:

The conditions:
Larmor frequency of 500.13 MHz
12 μs 30° pulse
A repetition time of 15.07 s
An acquisition time of 3.07 s
A relaxation delay of 12 s
300 scans.

For the measurements:
α-1,4 linkages: peak intensity at 5.11 ppm,
α-1,6 linkages: peak intensity at 4.75 ppm

So, the high soluble pea starch of the invention has an α-1,4/α-1,6 ratio between 23 to 32%.

By comparison:
native pea starch presents a typical α-1,4/α-1,6 ratio of about 24% to 31%
GLUCIDEX® 12 has an α-1,4/α-1,6 ratio of about 22% to 23%

Such product can be advantageously used in food application such as for flavor encapsulation, as exemplified below.

The invention relates also to a method of preparation of a high soluble starch that comprises or consists in:
Preparation of a starch slurry,
Gelatinization of the starch slurry,
Cooking of the gelatinized starch,
Refining of the thermal decomposed solution such obtained with active carbon, filtration and evaporation, and
drying of the concentrated solution to obtain a powder product.

According to the present invention, the term “high soluble starch” means a water solubility of starch (water at around 20° C.) more than 95% in weight, more preferably more than 98% in weight.

The method of preparation of a high soluble starch is preferably for preparing a high soluble starch as described above.

First step: Preparation of a starch slurry.

The starch in the initial starch-water mixture represents 5 to 30% by weight with respect to the total weight of the starch-water mixture.

The starch in the initial starch-water mixture may represent 5 to 20% by weight with respect to the total weight of the starch-water mixture, or 10 to 35% by weight with respect to the total weight of the starch-water mixture, more preferably 15 to 30%.Target: prepare a slurry containing starch at 15% by weight with respect to the total weight of the slurry. The mixture is then stirred at room temperature, as described in the Examples.

Starch used in that step may be from legume.

By “legume” for the purposes of the present invention, is understood to mean any plant belonging to the families, Mimosaceae or Papilionaceae of and in particular any plant belonging to the family of Papilionaceae, for example, the pea, haricot bean, broad bean, horse bean, lentil, alfalfa, clover or lupine.

This definition includes in particular all the plants described in any one of the Tables contained in the article by R. HOOVER et al. entitled “Composition, Structure, Functionality and Chemical Modification of Legume Starches: a review” (Can. J. Physiol. Pharmacol. 1991.69 pp. 79-92).

Preferably the starch useful for the present invention is a native leguminous starch. Thus, the starch used in the preparation of the starch slurry is preferably a native leguminous starch.

Preferably, the legume is selected from the group comprising pea, fava bean, haricot bean, broad bean and horse bean, more preferably pea or faba bean starch.

Advantageously, it is pea, the term “pea” being considered here in its broadest sense and including in particular:
all the wild varieties of “Smooth PEA”, and
all the mutant varieties of “smooth pea” and of “wrinkled pea” (“wrinkled PEA”) and this, regardless of the uses to which said varieties are generally intended (human consumption, animal nutrition and/or other uses).

Said mutant varieties are especially those referred to as “r is mutants”, “Rb mutants”, “rug 3 mutants”, “rug mutants 4”, “rug mutants 5” and “LAM mutants” as described in the article by The C-liter HEYDLEY et al. entitled “Developing novel pea wrinkled pea” Proceedings of the isgri Symposium of the Industrial Biochemistry and Biotechnology Group of the Biochemical Society, 1996, pp. 77-87.

According to another advantageous variant, the legume is a plant, for example a variety of pea or of horse bean, giving seeds comprising at least 25%, preferably at least 40%, by weight of starch (dry/dry).

By “Legume starch” or “leguminous starch”, is understood to mean any composition extracted and this, of case in whatever way, from a legume and in particular from a Papilionaceae, and whose starch content is greater than 40%, preferably greater than 50% and even more preferably greater than 75%, these percentages being expressed as dry weight relative to the dry weight of said composition.

Advantageously, this starch content is greater than 90% (dry/dry). It may in particular be greater than 95%, including greater than 98%.

The starch slurry is then gelatinized and then cooked at higher temperature for multiple purpose:
Swelling starch granular,
Gelatinize starch and/or loose starch coils,
Reducing size and structure of starch by partially break down long molecular chains.

Second step: Gelatinization of the starch slurry.

Gelatinized starches can be obtained by treatment of gelatinization of hydro-thermal native starches in particular by steam cooking, jet-cooker cooking, cooking on a drum, cooking in kneader/extruder systems followed by drying for example in an oven, by hot air on a fluidized bed, on rotating drum, by atomization, by extrusion or by lyophilization.

The slurries of starch are typically heated through a starch cooker at 500 g/min flow at a temperature between 14° and 150° C.

Third step: cooking of the gelatinized starch under pressure

This cooking step or further heating treatment is typically carried out at a temperature up to 190° C., at a pressure of between 1.43 to 12.55 bar.

This cooking step or further heating treatment may be carried out at a temperature up to 175° C., at a pressure between 1.43 to 12.55 bar, more preferably at a pressure between 4.16 to 8.94 bar.

The cooking step may for example be carried out at a temperature of 175° C.±2° C. at a pressure set between 4.16 and 8.94 bar.

The the cooking step may for example be carried out at a temperature of 180° C.±2° C. at a pressure set between 9 and 9.5 bar.

This cooking or further heating treatment is usually carried out for between 5 min and 2 hours. When the cooking step or further heating treatment at a temperature up to 175° C., at a pressure of between 1.43 to 12.55 bar, more preferably at a pressure between 4.16 to 8.94 bar, it may preferably be carried out between 30 min and 2 hours, preferably between 30 and 60 min.

When the cooking step or further heating treatment at a temperature up to 190° C., at a pressure between 1.43 to 12.55 bar, more preferably at a pressure between 4.16 to 8.94 bar, it is preferably carried out between 5 and 30 min, preferably between 5 and 20 min.

Fourth step: Refining and drying

The resulted product is refined with active carbon, filtrated and evaporated to 30-70% dry solid concentrate the solution.

The decolored, then evaporated as syrup can be dried into powder form using dryer such as drum dryer, flash dryer, spray dryer, freeze dryer.

For example, by spray drying, the inlet temperature is between 150 to 250° C., more preferably between 170 to 190° C.; the outlet temperature is between 60 to 120° C., more preferably between 80 to 90° C.

So the product obtained:
Is cold water soluble, i.e. solubility 95% around 20° C.,
Have similar properties as maltodextrin (oligosaccharides DP2-DP20 content>30%),
Is clean label (no chemical additives).

The invention also concerns the use of the highly soluble leguminous starch of the invention in food applications as an alternative to maltodextrin, in particular for the preparation of bakery, sauce and dressing, dairy and beverage, more specifically as carrier for flavor encapsulation, for the formulation of fat free vinaigrette and for the preparation of powder beverage formulations.

### DESCRIPTION OF THE FIGURE

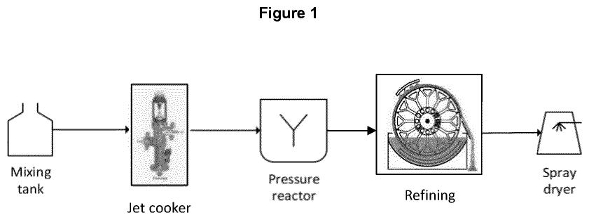

One FIG. 1 presents the pilot process developed following the invention.

### EXAMPLE

This invention will be better understood in light of the following example which are given for illustrative purposes only and do not intend to limit the scope of the invention, which is defined by the attached claims.

### Example 1. Preparation of the Soluble Pea Starch Following the Invention

### Material and Equipment

Raw material: Native pea starch N735 (commercialized by the Applicant),
Starch/Jet cooker commercialized by Bottom Line Process Technologies, Inc (referenced as laboratory Starch cooker)
Pressure cooker: Parr pressure reactor 8500
Refining & Spray dryer

### Process, Piloting Procedure and Operating Conditions

Process:

Pea starch and water are mixed in the mixing tank, liquefied by a starch/jet cooker and further thermal treated in a pressure reactor. After cooking, the solution was refined, and then spray dried to form soluble pea starch powder.

Piloting procedure and operating conditions:

The steps of the piloting procedure and related operating conditions are listed below:
Mix 4500 g of pea starch commercialized by the Applicant under the reference N735 with 25,500 g tap water to form 30,000 g starch-water mixture with starch concentration of ~15% by weight,
The mixture was stirred in the mixing tank at room temperature for 15 minutes,
Pump the starch slurry through a starch cooker at 500 g/min flow, with the heating temperature at 140~150° C.,
discharge the gelatinized starch slurry to a pressure vessel;
Continue cooking the starch slurry in the pressure vessel until 175° C. and keep there for 45 minutes.
Flashing the product to a flashing tank, cool down the cooked solution with cooling coil to 80° C.
Refining the product with 0.1-0.3% active carbon for 45 min and pass a press filter.
Spray dry the solution with the condition of inlet temperature 190° C. and outlet temperature 90° C.

### Sample Analysis

Solubility measurement (MERDGN 1002EN)
Collect 45 ml sample in 50 ml centrifuge tube at room temperature.
Centrifuge the sample at 3000 g for 5 minutes.
Supernatant was collected and weighted.
Dry the supernatant at 130° C. for two hours until constant weighting.
Cool the dried supernatant in desiccator at room temperature for 1 hour.
The solubility was calculated by the question:

$$100 * m * ( M + P ) / ( P 1 * P )$$

where: M=mass of water, P=mass of starch, P1=mass of supernatant,
m=mass of dried residual.
Measurement was repeated twice for accuracy.

P and M respectively refer to the masses of water and starch in the sample.

These are measured before spray-drying.

Dextrose equivalent and carbohydrate profile measurements
Dextrose equivalent (DE) of pilot samples were determined by any method well known in the art. (MERDGN 1005EN)
The carbohydrate profiles were determined by HPLC with double-silver column.

### Viscosity Measurement

Dissolve pilot products in deionized (DI) water at room temperature to form solutions at a concentration of 45% w/w;
Viscosity of the solutions was measured with Brookfield II viscometer using #21 spindle, at a temperature of 15° C., following the manufacturer's specifications.
Temperature of the solutions were controlled with circulated water bath.

### Results and Discussion

### Dextrin Equivalent and Carbohydrate Profile

Dextrin equivalent (DE) and carbohydrate profile (DP) are important information about the pilot product properties.

Labeled as soluble starch, the product must be soluble in cold water (water at around 20° C.) and contains low DP1 and DP2 concentration as well. For the feasibility trials, the current requirement for the product is: DE≈12, and DP1+DP2<5%.

Table 1 is the results of DE and DP measurements of the pilot products, with different batches. DE and DP results of commercial maltodextrin with DE12 (GLUCIDEX® 12 commercialized by the applicant) are also included on the table as comparison.

TABLE 1
Results of DE and DP measurements

| | Pilot batch | | | |
|---|---|---|---|---|
| Properties | Exp-01 | Exp-02 | EXP-03 | GLUCIDEX ® 12 |
| DE | 11.1 | 11.1 | 10.9 | 10.2 |

Carbohydrate profile (%)

| | | | | |
|---|---|---|---|---|
| Fructose | 0.86 | 0.65 | 0.33 | 0 |
| Glucose | 1.96 | 1.77 | 2.28 | 0.51 |
| Maltose | 2.03 | 1.86 | 2.27 | 2.33 |
| DP3 | 2.58 | 2.48 | 2.44 | 3.83 |
| DP4 | 2.67 | 2.63 | 2.6 | 3.24 |
| DP5 | 2.76 | 2.7 | 2.7 | 3.46 |
| DP6 | 3.13 | 3.22 | 2.75 | 4.36 |
| DP7 | 5.21 | 4.6 | 4.75 | 4.28 |
| DP8-20 | 15.12 | 15.87 | 17.03 | 24.93 |
| DP21+ | 60.7 | 60.8 | 60.3 | 53.1 |
| DP1 + DP2 | 4.85 | 4.28 | 4.88 | 2.84 |

The results indicate that the pilot products have DE values around 11 with the range of 10.9 to 11.1; and have DP1+DP2 concentration around 4-5% (between 4.28 and 4.88%).

The DP distribution of the pilot product is similar to the reference sample.

### Solubility

Another important property parameter is solubility. The soluble starch should have high enough solubility in cold water in order to be used as an alternative of maltodextrin.

### Viscosity

Viscosity directly affects the product applicability and processing-ability; it also reflects the effects of processing conditions on the final products. Currently, viscosity of the commercial DE12 sample is used as reference. Comparative studies

The data are presented in the following Table 2:

| | | | | | α-1,4/ | DP1 and | | |
|---|---|---|---|---|---|---|---|---|
| | Starch | | Viscosity | | α-1,6 | DP2 | DP3 and | |
| Sample | Content | Solubility | (15° C.-45%) | | ratio | content | higher | DE |
| Native pea | >99% | <2% | 20 | cP | 24-31% | 0.0% | / | / |
| starch N735 | | | | | | | | |
| commercialized | | | | | | | | |
| by the Applicant | | | | | | | | |
| Highly Soluble | <10% | >90% | 100-500 | CP | 23-27% | 4-5% | 95-96% | 11 |
| pea starch of | | | | | | | | |
| the present | | | | | | | | |
| example | | | | | | | | |
| GLUCIDEX ® 12 | ND* | >93% | 300-600 | cP | 22-23% | 3-7% | >90% | 12 |
| commercialized | | | | | | | | |
| by the Applicant | | | | | | | | |

*ND: Not determined, because maltodextrin has no starch content (Iodine test not blue)

It is clear that the highly soluble pea starch of the invention is functionally a maltodextrin and structurally a starch.

### Example 2. Evaluation of the High Soluble Pea Starch Comparing GLUCIDEX® 12 in Flavor Encapsulation

The objective is here to compare soluble pea starch of Example 1 vs GLUCIDEX® 12 in the flavour encapsulation function.

One major application for maltodextrin is a cost-effective alternative to gum acacia as a film-forming wall material for encapsulating oils/flavors when spray drying.

One potential solution is to solubilize to the equivalent dextrose equivalent of a target maltodextrin which will hopefully have similar functionality in this application. Previous work has been conducted tested pilot scale soluble starch samples in a spray dried application. For this, a basic spray dried flavor formulation was derived using orange oil as a commonly tested flavor for spray dried application. To ensure a base line of functionality, literature was consulted to determine an optimal level of maltodextrin to gum acacia, wall material to core material, and solids to water. Additionally, an optimal input and output temperature were chosen to maximize oil retention without cracking the shells of the encapsulated flavors.

The soluble starch samples were compared to the maltodextrin control sample with common analytical comparisons including color, pH, particle size, and viscosity of solution (pre and post homogenization). As one major function of spray drying flavor is oxidation protection, a Oxidation study was conducted at different temperatures while monitoring peroxide value and free fatty acids to see if the soluble starch samples show similar or better oxidative stability to the maltodextrin control sample.

TABLE 3
Formulation & processing procedures

| | Solids/water | Wall/core | Malto/gum | | |
|---|---|---|---|---|---|
| Ingredient | ratio | ratio | ratio | Percentage | Wt. (g) |
| Water | 55% | — | — | 55 | 3712.5 |
| GLUCIDEX ®12 or | 45% | 80% | 80% | 28.8 | 1944 |
| Soluble pea starch | | | | | |
| Gum arabica | | | 20% | 7.2 | 486 |
| Orange oil | | 20% | — | 9 | 607.5 |
| | | | | 100 | 6750 |

TABLE 4

| | Lot from | |
|---|---|---|
| Name | Example 1 | DE |
| GLUCIDEX ® 12 | | 12 |
| Soluble pea starch | Exp-01 | 11.1 |
| from the invention | | |
| | Exp-02 | 11.1 |

Procedure:
1) Weight water. Heat up to 60*C while mixing with Silverson high shear mixer with fine mesh screen at 2000 rpm.
2) Slowly add glucidex 12 & gum arabic while increasing mixer speed from 2000→4000→6000→9000 rpm for 15 min. or until well dispersed.
3) Add orange oil at 9000 rpm for 5 min. until coarse emulsion formed.
4) Homogenize in two stage high pressure homogenizer at 500 bar (450 1st stage, 50 2nd stage).
5) Transfer homogenized solution to a pot and heat to 60° C., keep pot stirring at 250 rpm.
6) Pump solution into GEA Mobile Minor Pilot Scale Spray dryer and spray dry at an input temperature of 185° C. and output temperature of 90° C.

### Analytical Procedures

### Color

Equipment: Konica Minolta CM-5 Colorimeter
Test Conditions: D65/10°
Measurement Scale: CIELAB Scale
1) Turn on and calibrate white measurement of colorimeter.
2) Place flat portion of sample over 30 mm equipment opening to as to completely cover color measurement area.
3) Place sample on colorimeter and press “Measure”
4) Once color measurement taken, repeat steps 3-4 for a total of 3 measurements, changing position of plant-based cheese samples to record more representative color measurements.
5) Record average of 3 color measurements
6) Compare the ΔE* values between the three samples to see how perceptible any differences in color are between the three samples.

AE scale:
<=1.0: Not perceptible by the human eye
1-2: Perceptible through close observation
2-10: Perceptible at a glance
11-49: Colors are more similar than the opposite
1 00: Colors are exactly the opposite

$$\% Solids / \% Moisture ( oven drying )$$

Equipment: VWR Forced Air Oven, Chemy Desiccator with Dri-Rite, Analytical Scale, 43 mm Aluminum Dish Pans (Stored Dry), Oven Gloves, and Tongs. Test Conditions: Oven Temperature & Time of 100° C. for 24 Hours, Desiccator Time of 1 Hour.

Measurement Scale/Units: Moisture Content on a Wet Basis (%)
1) Obtain dried aluminum pans from a desiccator with Dri-Rite.
2) Place an aluminum pan on an analytical scale and record the weight in grams (P), then tare out the scale.
3) Add about 4 grams of sample to the aluminum pan and record the weight of both the aluminum pan and the sample together (W1)—this is part of the initial weight. 4) Weigh up samples in triplicate per test variable. Label each sample uniquely to track the weight change.
5) Add the samples to a baking sheet pan and place them in the VWR Forced Air Oven set to 100° C. for 24 Hours (place them on the bottom rack to avoid the fan blowing the powders around).
6) After 24 hours have passed, grab oven gloves and tongs, then remove the samples carefully from the oven and transfer them to a desiccator containing Dri-Rite.
7) Allow the samples to further dry in the desiccator for at least 1 hour and then remove them.
8) Weigh each uniquely labeled aluminum pan and record this weight—this weight is part of the final weight (W2).
9) Calculate the moisture content on a wet basis (%) for each of the samples using the following equation:

$$Moisture Content \% ( Wet Basis ) = [ [ ( W 1 - P ) - ( W 2 - P ) ] / ( W 1 - P ) ] * 100$$

$$Density / specific gravity - untapped$$

Equipment: Analytical Scale, 250 mL Graduated Cylinders, Funnels, and an Elcometer Density Cup Model 1800 (50 cm3 Volume)
Test Conditions: Sample Temperature of 20-23° C.
Measurement Scale/Units: Specific Gravity (g/mL)

Powder-Based Measurement:
1) Place a 250 mL graduated cylinder on an analytical scale and tare out the scale. 2) Using a funnel, fill the graduated cylinder roughly to the 200-220 mL mark with the powder sample.
3) Record the weight (in grams) displayed on the analytical scale and the volume (in mL) in the graduated cylinder.
4) Divide the weight (g) by the volume (mL) recorded to obtain the specific gravity (g/mL).
5) Perform this testing in triplicate for each powder sample.

Liquid-Based Measurement:
1) Place a 50 cm3 Elcometer Density Cup on an analytical scale and tare out the scale (with the lid on the density cup).
2) Remove the lid off of the density cup and fill up the cup with the liquid sample near the top rim of the container.
3) Reapply the lid to the density cup and press down on the lid gently allowing excess fluid to release from the container.
4) Thoroughly clean off the sides of the enclosed density cup using paper towels.
5) Record the weight (in grams) displayed on the analytical scale and the volume (in mL) of the density cup holding the sample (i.e., 50 mL).
6) Divide the weight (g) by the volume (mL) recorded to obtain the specific gravity (g/mL).
7) Perform this testing in triplicate for each liquid sample.

$$Density / specific gravity - tapped ( powder measurements )$$

Equipment: Analytical Scale, 250 mL Graduated Cylinders, Funnels, and a QUANTACHROME© AUTOTAP AT-6

Test Conditions: Sample Temperature of 20-23° C., 1300 Taps

Measurement Scale/Units: Specific Gravity (g/mL)
1) Place a 250 mL graduated cylinder on a scale and tare out the scale.
2) Using a funnel, fill the graduated cylinder roughly to the 200-220 mL mark with the powder sample.
3) Record the weight (in grams) displayed on the analytical scale.
4) While covering the top of the graduated cylinder tightly and securely with your hand, invert the graduated cylinder back and forth 6-7 times.
5) Slowly set the graduated cylinder upright, ensure the surface of the powder bed is level, and avoid tapping the powder (causing compression).
6) Clamp the graduated cylinder tightly onto the platform of the Autotap AT-6.
7) Set the tap number to 1300 taps. Press start on the device.
8) Once the process has finished, record the final volume (mL) in the graduated cylinder.
9) Divide the weight (g) by the final volume (mL) to obtain the tapped density-specific gravity (g/mL).
10) Perform this testing in triplicate for each powder sample.

### Particle Size Distribution

Equipment: Malvern Mastersizer3000, Malvern Hydro EV, 500 mL Beaker, and Deionized Water

Test Conditions: Sample Temperature of 20-23° C.

Measurement Scale/Units: Particle Size Distribution (μm)
1) Turn on the Malvern Mastersizer 3000. Allow the samples to equilibrate to room temperature (~20-23° C.)
2) Fill up a 500 mL beaker with deionized water and place this under the Malvern Hydro EV apparatus.
3) Run an SOP for the experiment (Spray Dried Orange Oil) and name each run.
4) Edit the SOP and enter the average density and the refractive index measurements of the sample being tested.
5) Allow the machine to measure the background light before adding the sample to the device. Typically, the device will be ready once the background light reading stabilizes to 0 to −50 mV.
6) Add the sample to the 500 mL beaker dropwise (slowly) until reaching the green region in a bar displayed on the computer (indicating that enough sample has been added for analysis). Then, click on the start button, to begin the analysis.
7) The device will automatically collect 5 sets of measurements.
8) Once complete, the system will automatically enter a cleaning mode—requiring three changes of deionized water to occur before testing a separate sample.
9) Repeat this testing on additional samples.

### pH Testing

Equipment: Hannah H₁₁₁₃₁₂ pH Meter, Halo pH Probe, and Buffer Solutions (pH 4.01, 7.00, 10.01)

Test Conditions: Sample Temperature of 23±5° C.

Measurement Scale/Units: Measurement of Electrode Voltage (mV) in Reference to pH: −log [H⁺]. H⁺(or H₃O⁺)=Free Hydrogen Ions

pH Range: 1.00 (Acidic) −14.00 (Basic)
1) Turn on the pH meter and the Bluetooth probe (ensure that the probe is connected).
2) Unscrew and remove the electrode fill hole cover from the probe.
3) Calibrate the pH probe by submerging it ~⅓ of its' length into buffer solutions. Calibrate the probe starting in the pH 7.00 buffer solution, then the pH 4.01 buffer solution, and finally the pH 10.01 buffer solution. a. Allow the probe to stabilize at a reading for at least 30 seconds before confirming the calibration point.
b. Ideally, you would like to see a pH calibration slope of 98-102% for normal testing conditions and 99.5-100.5% for food safety intensive products.
4) Following calibration, begin taking pH readings of the samples tempered close to room temperature (23° C.). Allow the pH reading to stabilize at a point for at least 30 seconds before recording the measurement.

$$Viscosity - RVA viscometer$$

Equipment: RVA 4500 Viscometer with Julabo F12-ED Refrigerated/Heating Circulator, Plastic Paddles, and Aluminum Canisters

Test Conditions: Incubation Temperature of 20° C., Mixing Rate of 160 rpm, Holding Time of 10 Minutes, Sample Weight of 28 g.

Measurement Scale/Units: Viscosity (cP)
1) Turn on both the RVA Viscometer and the F12-ED Water Circulator.
2) Calibrate the Viscometer by attaching a plastic paddle to the coupling and zero the viscosity.
3) Powder Mix Application: Wait at least 15 minutes for the protein shake solution to equilibrate before beginning this test.
4) Run the desired program for the application that uses a temperature setpoint of 20° C., a mixing rate of 160 rpm, a holding time of 10 minutes, and a sample weight of 28 g.
5) Add 28 g of the sample to the aluminium canister.
6) Insert the plastic paddle into the filled canister and slide these two parts together into the RVA Motor Coupling (an audible click should be heard with plastic notches locking into the coupling).
7) Once the device displays, “Test Ready”, depress the RVA Tower into the RVA Viscometer to begin the test.
8) Record the terminal viscosity reading (cP) once the test completes.
9) Perform this testing in duplicate for each sample.

$$Total fats - acid hydrolysis$$

Method based on AOAC Official Method 996.06, Fat (Total, Saturated, and Unsaturated) in Foods.

### Surface Fats

Method based on AOAC Official Method 963.15, Fat in Cacao Products Soxhlet Extraction Method and JAOAC 28, 482(1945); 33, 342(1950); 34, 442(1951); 53, 490(1970)

### Free Fatty Acids

Method: Based on AOAC Official method method 965.33

### Peroxide Value

Method: Based on AOAC Official method 940.28

### Oxidation Study Procedure

1) 20 g of Spray dried flavors were packed into small metallized bags, induction sealed, and labeled.
2) A control sample of orange oil was measured into glass bottles and capped with a rubber seal.
3) Samples were split and placed under four different testing conditions to develop different levels of oxidation
   a. C1: Frozen (−112° F./−80° C.) conditions, control.
   b. C2: Ambient Temperature (20° C./68° F.), 40% RH.
   c. C3: Accelerated Conditions (100° F., 37.78° C.), 60% RH. 1 Week=1 Month Ambient conditions.
   d. C4: Accelerated Conditions (130° F., 54.44° C.), 60% RH. 1 Week=3 Months ambient conditions.
4) Every week, samples from conditions C3 and C4 were pulled and frozen at −112° F./−80° C. Every month, samples C1 and C2 were pulled and frozen at −112° F./−80° C. At this temperature, it is assumed that further oxidation is halted. Assuming an average shelf life of 18 months, the samples were pulled according to the following timelines:
   a. C1: Pulled every mon the for 18 Months (72 Weeks) or until testing is halted.
   b. C2: Pulled every mon the for 18 Months (72 Weeks) or until testing is halted.
   c. C3: Pulled for 4 Months (18 weeks). 1 week 1 month.
   d. C4: Pulled for 2 Months (9 weeks). 1 week=3 months.
5) Once pulled and frozen, the samples were thawed at room temperature and measured for peroxide value and free fatty acid.

The samples were compared to see if the samples spray dried were soluble starch were equivalent to the sample spray dried with GLUCIDEX® 12 as well as seeing if the samples were suitable spray dried flavor analogs with acceptable oxidation over the average shelf life of a spray dried flavor. While different compounds can have differing intensities of off notes at different levels of oxidation, in general a peroxide value <10-20 meq. Is indicative of no rancidity off-notes developing.

### Analytical Results

Post-homogenization emulsions (target 45% solids):

% Solids, gravimetric at 100° C., 24 hours.

The measured solids of the emulsions with soluble lots Exp-01 and Exp-02 were both slightly higher than the control emulsion with GLUCIDEX® 12. This likely occurred from during the homogenization step where subsequent runs were timed better to reduce the amount of dilution that occurred during when transferring the solution to and from the homogenizer.

A sample of the liquid orange oil was spray dried to see its level of volatiles. Almost the entirety of the orange oil is volatile (~97%) and would contribute to the moisture content measured in the emulsions and spray dried flavor.

There were no notable differences observed in stained microscope photos (stained with 0.1N iodine solution) of post-homogenized emulsions with GLUCIDEX® 12, Lot Exp-01, and Lot Exp-02 except for less observable dense starch molecules seen in the GLUCIDEX® 12 emulsion at 40× magnification.

TABLE 5
Color:

| Sample | L* | a* | b* | ΔE | |
|---|---|---|---|---|---|
| GLUCIDEX ® 12 Pilot Run - | 83.48 | −1.63 | 31.39 | | |
| Post Homo Emulsion | | | | | |
| Lot Exp-01 Pilot Run - | 81.17 | −0.9 | 27.45 | 4.63 | |
| Post Homo Emulsion | −2.31 | 0.73 | −3.94 | | |
| Lot Exp-02 Pilot Run - | 78.97 | −0.92 | 27.52 | 5.99 | 2.20 |
| Post Homo Emulsion | −4.51 | 0.71 | | | |

With AE>2, there is a “perceivable at a glance” for both post-homogenization emulsions with soluble starch lots Exp-01 and EXP-02 against the control emulsion with GLUCIDEX® 12. These samples tended to be darker, slightly redder, and less yellow. This color difference likely occurs from the residual carbon that is present in the soluble starch from its production and was seen even more prominently in earlier soluble starch test samples. This color difference may persist through the spray drying process though is not a major concern at this time because filtering during industrial production will likely be more efficient and less the color difference.

TABLE 6
Density/Specific gravity

| | Wt(g) | | | Density (g/mL) | | | |
|---|---|---|---|---|---|---|---|
| Sample | 1 | 2 | 3 | 1 | 2 | 3 | Average |
| GLUCIDEX ® 12 Pilot | 56.4038 | 56.438 | 56.509 | 1.128 | 1.129 | 1.130 | 1.129 |
| Run - Post Homo | | | | | | | |
| Emulsion | | | | | | | |
| Lot Exp-01 Pilot | 56.6561 | 56.704 | 56.721 | 1.133 | 1.134 | 1.134 | 1.134 |
| Run - Post Homo | | | | | | | |
| Emulsion | | | | | | | |
| Lot Exp-02 Pilot | 57.4876 | 57.503 | 57.5311 | 1.150 | 1.150 | 1.151 | 1.150 |
| Run - Post Homo | | | | | | | |
| Emulsion | | | | | | | |

There is a slight increase in the specific gravity of the post-homogenized emulsions seen with the soluble pea starch Lot Exp-01 and soluble pea starch Lot Exp-02. This difference is negligible for the soluble pea starch Lot Exp-01 and a slight increase for the soluble pea starch Lot Exp-02.

This difference can be explained with an increase in solids seen for both soluble starch samples that likely occurred from less dilution during the homogenization step of processing and it would be expected that this difference would disappear when reconstituting the spray dried flavors to a similar level of solids.

TABLE 7
pH

| Sample | pH |
|---|---|
| GLUCIDEX ® 12 Pilot Run - | 4.95 |
| Post Homo Emulsion | (21° C.) |
| Lot Exp-01 Pilot Run - | 4.38 |
| Post Homo Emulsion | (19.8° C.) |
| Lot Exp-02 Pilot Run - | 4.34 |
| Post Homo Emulsion | (22.9° C.) |

The pH of the soluble starch emulsions were similarly slightly lower than the control post-homogenized emulsion with GLUCIDEX® 12. This could be due to a lower initial pH of the soluble starch samples vs. the GLUCIDEX® 12 as well as the slightly higher solids content of both soluble pea starch samples.

TABLE 8
Viscosity

| | D + 0 | | | D + 1 | | | Δ |
|---|---|---|---|---|---|---|---|
| Sample | 1 | 2 | Average | 1 | 2 | Average | viscosity |
| GLUCIDEX ® 12 Pilot | 202.0 | 200 | 201.0 | 210 | 211 | 210.0 | 9.5 |
| Run - Post Homo | | | | | | | |
| Emulsion | | | | | | | |
| Lot Exp-01 Pilot | 290.0 | 291 | 290.5 | 420 | 427 | 423.5 | 133.0 |
| Run - Post Homo | | | | | | | |
| Emulsion | | | | | | | |
| Lot Exp-02 Pilot | 700.0 | 708 | 704.0 | 1014 | 1016 | 1015 | 311.0 |
| Run - Post Homo | | | | | | | |
| Emulsion | | | | | | | |

The viscosity of the post-homogenized emulsions was taken during similar time points (~4 hours after initial production) at day=0. There was a notable increase in viscosity of the emulsions with soluble starch vs. the emulsion with GLUCIDEX® 12. This is not surprising as earlier samples of soluble starch showed a notable degree of retrogradation which increased the viscosity of their respective emulsions. What was surprising was the larger increase in viscosity between the emulsions with soluble pea starch Lot Exp-01 and Lot Exp-02. As these are two similar batches for the same product, it is expected to see comparable analytical characteristics. The emulsion with soluble starch Lot Exp-02 did have a slightly higher solids content than the emulsion with Lot Exp-01, however it was not so much as to have this degree in viscosity difference be expected. To see if this effect is consistent, the viscosities of reconstituted emulsions will be compared to see if this effect persists.

One issue that having a higher viscosity could cause is that a manufacture may have issues pumping the product to the spray drier if the viscosity is too high. This difference in viscosity was noted during the pilot processing with an increase in needed pump flow for the emulsion with soluble starch Lot Exp-02. While this effect was notable during processing, it did not cause any issues with the spray drying itself. The increase in viscosity for the emulsion with soluble starch Lot Exp-01 did not produce a noticeable difference in processing against the control emulsion with GLUCIDEX® 12.

TABLE 9
Particle size distribution

| Sample | | Dx10 | Dx50 | Dx90 | D(3,2) | D (4,3) |
|---|---|---|---|---|---|---|
| GLUCIDEX ® 12 Pilot | Mean Particle size (μm) | 0.253 | 1.19 | 8.02 | 0.581 | 12.8 |
| Run - Post Homo | Std Deviation (μm) | 0.0105 | 0.0239 | 5.56 | | |
| Emulsion | RSD | 4.15 | 2.01 | 69.4 | | |
| Lot Exp-01 Pilot | Mean Particle size (μm) | 0.228 | 1.6 | 13.9 | 0.548 | 13.9 |
| Run - Post Homo | Std Deviation (μm) | 0.0116 | 0.0726 | 1.4 | | |
| Emulsion | RSD | 5.09 | 4.55 | 10.1 | | |
| Lot Exp-02 Pilot | Mean Particle size (μm) | 0.366 | 2.91 | 13.1 | 1.09 | 4.77 |
| Run - Post Homo | Std Deviation (μm) | 0.0256 | 0.478 | 0.915 | | |
| Emulsion | RSD | 7.00 | 16.4 | 7.00 | | |

There was an overall difference in particle size between the post-homogenized emulsions with soluble starch Lots Exp-01 and Exp-02 against the post homogenized emulsion with GLUCIDEX® 12. There was a slight increase in Dx50 and Dx90 for both samples as they have a higher fraction of particles around the 10 μm range whereas the emulsion with GLUCIDEX® 12 which had a higher fraction around the 1.0 μm range. The mean particle size was similar for the soluble starch Lot Exp-01 and the control GLUCIDEX® 12 and lower for the soluble starch Lot Exp-02 as the first two emulsions had a slightly higher fraction of particles in the 100 μm range.

Reconstituted Emulsions (45% solids):

% Solids, gravimetric at 100° C., 24 hours.

TABLE 10

| | % Solids | | | % Moisture | | | Δ % Solids | |
|---|---|---|---|---|---|---|---|---|
| Sample | 1 | 2 | Average | 1 | 2 | Average | Average | |
| GLUCIDEX ® 12 Pilot | 43.67 | 43.62 | 43.6 | 56.33 | 53.68 | 56.4 | — | — |
| Run - Reconstituted | | | | | | | | |
| Lot Exp-01 Pilot | 53.65 | 43.69 | 43.6 | 56.35 | 56.51 | 56.4 | −0.1 | — |
| Run - Reconstituted | | | | | | | | |
| Lot Exp-02 Pilot | 43.16 | 43.2 | 43.2 | 56.77 | 56.77 | 56.8 | −0.5 | −0.4 |
| Run - Reconstituted | | | | | | | | |

To see if the differences seen in the post-homogenized emulsions persist in the samples after spray drying, all three spray dried powders were reconstituted to ~45% solids, the same level they would be at during the initial processing/spray drying. Taking a moisture measurement of these samples, these showed similar levels of solids, equivalent to the level of solids seen in the post homogenized emulsion with soluble starch Lot Exp-02.

Under microscopy, the reconstituted emulsions did not show any notable differences between the GLUCIDEX®12 and the soluble starches E9827-1&3.

TABLE 11
Color:

| Sample | L* | a* | b* | ΔE | |
|---|---|---|---|---|---|
| GLUCIDEX ® 12 Pilot Run - | 80.02 | −0.99 | 33.44 | | |
| Reconstituted | | | | | |
| Lot Exp-01 Pilot Run - | 77.46 | 0.54 | 27.93 | 6.27 | |
| Reconstituted | −2.56 | 1.53 | −5.51 | | |
| Lot Exp-02 Pilot Run - | 76.5 | 0.55 | 27.69 | 6.92 | 0.99 |
| Reconstituted | −3.52 | 1.54 | −5.75 | | |

Like the post homogenized emulsion, the reconstituted emulsions showed color differences to the control emulsion with GLUCIDEX® 12, though with the equalized solids content, the differences are slightly more pronounced. Both soluble starch emulsions were darker, redder, and less yellow than the control emulsion with GLUCIDEX® 12. With a ΔE<1, there was no perceivable color difference between the emulsion with soluble starch Lot Exp-01 and the emulsion with soluble starch Lot Exp-02.

TABLE 12
Density/Specific gravity

| | Wt(g) | | | Density (g/mL) | | | |
|---|---|---|---|---|---|---|---|
| Sample | 1 | 2 | 3 | 1 | 2 | 3 | Average |
| GLUCIDEX ® 12 Pilot | 57.7536 | 57.351 | 57.4602 | 1.155 | 1.147 | 1.149 | 1.150 |
| Run - Reconstituted | | | | | | | |
| Lot Exp-01 Pilot | 57.2581 | 57.349 | 57.3514 | 1.145 | 1.147 | 1.147 | 1.146 |
| Run - Reconstituted | | | | | | | |
| Lot Exp-02 Pilot | 57.3765 | 57.3765 | 57.492 | 1.148 | 1.149 | 1.150 | 1.149 |
| Run - Reconstituted | | | | | | | |

When reconstituted to similar solids content, the density differences of the samples equalize and become statistically similar.

TABLE 13
pH

| Sample | pH |
|---|---|
| GLUCIDEX ® 12 Pilot Run - | 4.48 |
| Reconstituted | (20.4° C.) |
| Lot Exp-01 Pilot Run - | 4.47 |
| Reconstituted | (20.3° C.) |
| Lot Exp-02 Pilot Run - | 4.44 |
| Reconstituted | (20.3° C.) |

When reconstituted to a similar solids content, the pH differences between the emulsions with GLUCIDEX®12 and soluble starch Lot Exp-01 and Exp-02 equalize to a difference of at most 0.4 pH which would have minimal to no effect during processing or in application.

TABLE 14
Viscosity

| | D + 0 | | | D + 1 | | | Δ |
|---|---|---|---|---|---|---|---|
| Sample | 1 | 2 | Average | 1 | 2 | Average | viscosity |
| GLUCIDEX ® 12 Pilot | 296 | 298 | 297.0 | 321 | 322 | 321.5 | 24.5 |
| Run - Reconstituted | | | | | | | |
| Lot Exp-01 Pilot | 294 | 291 | 292.5 | 534 | 542 | 538.0 | 245.5 |
| Run - Reconstituted | | | | | | | |
| Lot Exp-02 Pilot | 306 | 298 | 302.0 | 545 | 554 | 549.5 | 247.5 |
| Run - Reconstituted | | | | | | | |

Viscosity of the reconstituted emulsions were taken at similar times as the post-homogenization emulsions (~4 hours after production D+0 and D+1). Like the post-homogenization emulsion, the soluble starch samples showed a greater increase in viscosity compared to the emulsion with GLUCIDEX®12. So, the potential issue with greater retrogradation still occurs after spray drying. Though this would only be a concern with applications that use a large amount of the spray dried flavor in an emulsion and store this emulsion overtime.

However, unlike the post-homogenization emulsion, the D+0 viscosities were statistically similar to the control emulsion with GLUCIDEX® 12 at D+0. At equalized solids content, the GLUCIDEX®12 and soluble starches seem to impart similar viscosities during the initial processing time. Also different from the post homogenized emulsion, the two soluble starch emulsions show similar D+0 viscosities and similar increases to their D+1 viscosities, unlike the greater increase with the post homogenized emulsion with soluble starch Lot Exp-02. Either the small difference in solids content contributed to the large increase seen in the post-homogenized emulsion or the spray drying process removed any difference in retrogradation between the two samples.

TABLE 15
Particle size distribution

| Sample | | Dx10 | Dx50 | Dx90 | D(3,2) | D (4,3) |
|---|---|---|---|---|---|---|
| GLUCIDEX ® 12 Pilot | Mean Particle size (μm) | 0.325 | 1.39 | 19.9 | 0.788 | 13.3 |
| Run - Reconstituted | Std Deviation (μm) | 0.00792 | 0.0305 | 10.5 | | |
| | RSD | 7 | 2.19 | 52.7 | | |
| Lot Exp-01 Pilot | Mean Particle size (μm) | 0.219 | 1.42 | 9.23 | 0.55 | 6.3 |
| Run - Reconstituted | Std Deviation (μm) | 0.00725 | 0.0432 | 10.5 | | |
| | RSD | 3.31 | 3.04 | 52.7 | | |
| Lot Exp-02 Pilot | Mean Particle size (μm) | 0.317 | 1.89 | 10.8 | 0.833 | 8.98 |
| Run - Reconstituted | Std Deviation (μm) | 0.0243 | 0.0994 | 1.14 | | |
| | RSD | 7.65 | 5.27 | 10.5 | | |

There is a difference in particle size distribution in the reconstituted emulsions with GLUCIDEX®12 vs. soluble starch Lots Exp-01 and Exp-02 vs. their post-homogenized emulsions. There is still a slight increase in Dx(50) for the soluble starch emulsions, but their Dx(90) is slightly lower than the GLUCIDEX®12 emulsion, due to a lower fraction of particles in the 100 μm range. This also contributed to lower median particle sizes to the emulsions with soluble starch.

Spray Dried Orange Oil Powder:

% Solids, gravimetric at 100° C., 24 hours

TABLE 16

| | % Solids | | | % Moisture | | | | |
|---|---|---|---|---|---|---|---|---|
| Sample | 1 | 2 | Average | 1 | 2 | Average | Δ % Solids | |
| GLUCIDEX ® 12 | 97.66 | 97.69 | 97.67 | 2.34 | 2.31 | 2.33 | | |
| Spray-dried | | | | | | | | |
| Lot Exp-01 | 97.77 | 96.47 | 97.12 | 2.23 | 3.53 | 2.88 | −0.55 | |
| Spray-dried | | | | | | | | |
| Lot Exp-02 | 97.52 | 97.50 | 97.51 | 2.48 | 2.50 | 2.49 | −0.16 | 0.39 |
| Spray-dried | | | | | | | | |

The spray dried orange oil samples had similar moisture levels to each other with the spray dried orange oil samples with soluble starch having a comparable to slightly higher moisture content compared to the spray dried orange oil with GLUCIDEX®12.

TABLE 17
% Total Fat

| | | | T + Fat | Fat | | | % Total | | |
|---|---|---|---|---|---|---|---|---|---|
| | Sample | | reside | residue | | | Orange | Δ % | |
| Sample | Wt | tare | Wt. | Wt. | % Fat | Average | Oil | Orange Oil | |
| Orang oil- control | 2.434 | 78.8979 | 79.6802 | 0.7823 | 32.14 | 3.71 | — | | |
| | 2.1365 | 76.5601 | 77.1857 | 0.6256 | 29.28 | | | | |
| Spray-dried Flavor with | 2.1443 | 14.4048 | 74.7036 | 0.2988 | 13.93 | 14.28 | 46.5 | | |
| GLUCIDEX ® 12 | 2.1785 | 19.4170 | 79.7357 | 0.3187 | 14.63 | | | | |
| Spray-dried Flavor with | 2.069 | 78.9857 | 79.2868 | 0.3011 | 14.55 | 13.73 | 44.7 | −1.80 | |
| Lot Exp-01 | 2.1228 | 78.9960 | 79.2699 | 0.2739 | 12.90 | | | | |
| Spray-dried Flavor with | 2.1432 | 76.0106 | 76.2778 | 0.2672 | 12.47 | 13.66 | 44.5 | −2.01 | −0.20 |
| Lot Exp-02 | 2.0683 | 80.7969 | 81.1043 | 0.3074 | 14.86 | | | | |

By calculating the amount of fat present in the orange oil itself, as well as the amount of fat present in the spray dried orange oil samples, it is possible to calculate the amount of orange oil present in each orange oil sample. The spray dried orange oil samples with soluble starch Lots Exp-01 and Exp-02 had a slightly lower but statistically similar amount of orange oil compared to the spray dried orange oil with GLUCIDEX®12. Each sample had a calculated amount of ~45% orange oil.

TABLE 18
Surface Oil

| | | | | | | | % Surface |
|---|---|---|---|---|---|---|---|
| | | Tare | T + Fat | Fat | % | | Orange Oil |
| | Sample | flask + | Reside | residue | Surface | Calculated % | to Total |
| Sample | Wt. | chips | Wt | Wt. | Fat | Surface Oil | Orange |
| Spray-dried Flavor | 2.3786 | 119.4991 | 119.5032 | 0.0041 | 0.17 | 0.56 | 0.37 |
| with GLUCIDEX ® 12 | | | | | | | |
| Spray-dried Flavor | 2.912 | 171.2024 | 171.2087 | 0.0063 | 0.22 | 0.70 | 0.48 |
| with Lot Exp-01 | | | | | | | |
| Spray-dried Flavor | 2.6587 | 136.4068 | 136.4123 | 0.0055 | 0.21 | 0.67 | 0.46 |
| with Lot Exp-02 | | | | | | | |

To ensure that the orange oil is fully protected by the wall material, the surface oil of the spray dried flavor is measured to see how much of the total orange oil is plated on the spray dried wall material rather than encapsulated by the material itself.

Each sample had less than 1% calculated surface orange oil, with the spray dried orange oil with soluble starches Lot Exp-01 and Lot Exp-02 having slightly higher levels of surface oil compared to the control spray dried orange oil with GLUCIDEX®12. These come out to just under 0.5% of the total orange oil platted on the surface of the spray dried powder vs. being encapsulated by the wall material. This means all three samples showed good encapsulation of the orange oil and will more likely good oxidative protection of the orange oil itself.

TABLE 19
Color

| Sample | L* | a* | b* | ΔE | |
|---|---|---|---|---|---|
| GLUCIDEX ® 12 | 95.24 | −1.55 | 11.56 | | |
| Spray-dried | | | | | |
| Lot Exp-01 | 93.28 | −0.8 | 11.81 | 2.11 | 1.0 |
| Spray-dried | | | | | |
| Δ from control GLUCIDEX ® 12 | −1.96 | 0.75 | 0.25 | | |
| Lot Exp-02 | 92.92 | −0.83 | 12.75 | 2.70 | |
| Spray-dried | | | | | |
| Δ from control GLUCIDEX ® 12 | −2.32 | 0.72 | 1.19 | | |

With a ΔE>2, there is still a perceivable level of difference in color between the spray dried orange oil with GLUCIDEX®12 and the spray dried orange oil with soluble starches E9827-1&3. The spray dried orange oil flavors with soluble starches Lots Exp-01 and Exp-02 are darker, redder, and more yellow compared to the control sample which appears lighter and more white. However, this difference is notably reduced compared to their respective post-homogenized and reconstituted emulsions. As most applications tend to use flavors at low levels with other color-imparting ingredients, this is level of difference has a low risk of causing a noticeable difference of color in application. Additionally, as previously stated with the post-homogenized emulsion, industrial production should see more efficient filtering which would lessen the difference in color between emulsions with GLUCIDEX®12 and soluble starch.

TABLE 20
Bulk Density

| | | | | Bulk | | | Bulk density |
|---|---|---|---|---|---|---|---|
| | Wt (g) | | Volume | density (g/mL) | | | (g/L) |
| Sample | 1 | 2 | (ml) | 1 | 2 | Average | Average |
| GLUCIDEX ® 12 | 48.18 | 46.95 | 129.2112 | 0.37 | 0.36 | 0.37 | 368.1 |
| Spray-dried | | | | | | | |
| Lot Exp-01 | 45.74 | 45.94 | 129.2112 | 0.35 | 0.36 | 0.35 | 354.8 |
| Spray-dried | | | | | | | |
| Lot Exp-02 | 48.57 | 47.23 | 129.2112 | 0.38 | 0.37 | 0.37 | 370.7 |
| Spray-dried | | | | | | | |

The bulk densities of the spray dried orange oil samples were similar, with the bulk density between the spray dried orange oil with GLUCIDEX® 12 and soluble starch Lot Exp-02 being statistically similar. The bulk density of the spray dried orange oil with soluble starch Lot Exp-01 was slightly lower than the other two samples. So, the difference in bulk density of the spray dried orange oil with GLUCIDEX®12 was within batch-to-batch variation of the spray dried flavors with soluble starch.

TABLE 21
Tapped Density

| | | | | | | | | Tapped |
|---|---|---|---|---|---|---|---|---|
| | | | Final | | Tapped | | | density |
| | Wt (g) | | volume (ml) | | Density (g/ml) | | | (g/L) |
| Sample | 1 | 2 | 1 | 2 | 1 | 2 | Average | Average |
| GLUCIDEX ® 12 | 19.99 | 20 | 40 | 39 | 0.50 | 0.51 | 0.51 | 506.3 |
| Spray-dried | | | | | | | | |
| Lot Exp-01 | 20.51 | 20.1 | 41 | 42 | 0.50 | 0.48 | 0.49 | 488.9 |
| Spray-dried | | | | | | | | |
| Lot Exp-02 | 20.17 | 20.13 | 38 | 37 | 0.53 | 0.54 | 0.54 | 537.4 |
| Spray-dried | | | | | | | | |

For tapped density, the spray dried orange oil with GLUCIDEX®12 was statistically similar to the spray dried orange oil with soluble starch Lot Exp-01. The spray dried orange oil with soluble starch Lot Exp-02 was slightly higher than the other two samples. So, the difference in tapped density of the spray dried orange oil with GLUCIDEX®12 was within batch-to-batch variation of the spray dried flavors with soluble starch.

TABLE 22
Particle Size Distribution

| Sample | | Dx10 | Dx50 | Dx90 | D(3,2) | D (4,3) |
|---|---|---|---|---|---|---|
| GLUCIDEX ® 12 Pilot | Mean Particle size (μm) | 4.36 | 22.7 | 70.7 | 5.93 | 31.1 |
| Run - Reconstituted | Std Deviation (μm) | 0.43. | 0.329 | 0.584 | | |
| | RSD | 9.35 | 1.45 | 0.835 | | |
| Lot Exp-01 | Mean Particle size (μm) | 4.03 | 19.9 | 60.3 | 4.6 | 27.2 |
| Spray-dried | Std Deviation (μm) | 0.0235 | 0.255 | 0.787 | | |
| | RSD | 0.583 | 1.28 | 1.31 | | |

The particle size distribution of the spray dried orange oil with soluble starch E9827-1 was close to the particle size of spray dried orange oil with GLUCIDEX®12 and the Dx10, Dx50, Dx90, and mean particle size were all slightly smaller than the spray dried orange oil with GLUCIDEX® 12. From this, we can see at least one batch of the soluble starch spray dried similarly to the GLUCIDEX®12 control.

Oxidation study results—1 month

Condition C1 (Frozen) and Condition C2 (Ambient Condition)

Free fatty Acid Concentration:

TABLE 23

| | Sample | Thiosulfate | FFA | Average FFA |
|---|---|---|---|---|
| Sample | Weight (g) | volume | concentration | Concentration |
| Orang oil- control - C1 | 1.9513 | 0.26 | 0.3 | 0.32 |
| | 1.9636 | 0.28 | 0.33 | |
| GLUCIDEX ® 12 - C1 | 2.1376 | 0.22 | 0.224 | 0.20 |
| | 1.8939 | 0.20 | 0.18 | |
| Lot Exp-01 - C1 | 2.1175 | 0.70 | 0.82 | 0.81 |
| | 2.0034 | 0.65 | 0.8 | |
| Lot Exp-02 - C1 | 2.1118 | 0.70 | 0.82 | 0.79 |
| | 2.0143 | 0.62 | 0.75 | |

TABLE 24

| | Sample | Thiosulfate | FFA | Average FFA |
|---|---|---|---|---|
| Sample | Weight (g) | volume | concentration | Concentration |
| Orang oil- control - C2 | 1.986 | 0.30 | 0.355 | 0.35 |
| | 1.9193 | 0.28 | 0.34 | |
| GLUCIDEX ® 12 - C2 | 2.0233 | 0.24 | 0.225 | 0.23 |
| Lot Exp-01 - C2 | 2.0529 | 0.74 | 0.91 | 0.92 |
| | 1.8731 | 0.70 | 0.93 | |
| Lot Exp-02 - C2 | 2.0952 | 0.60 | 0.7 | 0.77 |
| | 2.0400 | 0.68 | 0.83 | |

TABLE 25
Peroxide value

| | Sample | Thiosulfate | | Average FFA |
|---|---|---|---|---|
| Sample | Weight (g) | volume | PV | Concentration |
| Orang oil- control - | 1.9354 | 0.88 | 3.5 | 3.685 |
| C1 | 1.9633 | 0.96 | 3.87 | |
| GLUCIDEX ® 12 - | 2.0475 | 0.1 | ND | ND |
| C1 | 2.0013 | ND | ND | |

TABLE 26

| | Sample | Thiosulfate | | Average FFA |
|---|---|---|---|---|
| Sample | Weight (g) | volume | PV | Concentration |
| Orang oil- control - | 1.9245 | 1.2 | 5.2 | 5.68 |
| C2 | 1.951 | 1.4 | 6.15 | |
| GLUCIDEX ® 12 - | 2.0233 | 0.2 | 0.6 | 0.51 |
| C2 | 1.8939 | 0.16 | 0.42 | |
| Lot Exp-01 - C2 | 2.0926 | 0.1 | 0.1 | ND |
| Lot Exp-02 - C2 | 1.962 | 0.1 | 0.1 | ND |

At the one-month point, the samples at the Frozen (C1) and ambient (C2) conditions were pulled and tested for Free Fatty Acid concentration and Peroxide Value. From the data, both the frozen and ambient conditions show similarly low levels of Free Fatty acids, which indicates little to no free fatty acids were generated under ambient or frozen conditions. The spray dried orange oil with soluble starches Lots Exp-01 and EXP-02 do have a slightly higher free fatty acid concentration than the orange oil and spray dried orange oil with GLUCIDEX® 12 which indicates some free fatty acids contributed by the soluble starch itself.

For peroxide value, the spray dried flavors with GLUCIDEX®12 and soluble starch had minimal to non-detectable oxidation. The control orange oil itself had some level base level of oxidation seen in the C1 frozen condition that was slightly higher in the ambient condition sample. This show some initial level of protection is contributed by both the GLUCIDEX®12 and the soluble starches.

Condition C3: 37.8° C. at 60% RH

Free Fatty Acid Concentration

TABLE 27

| Sample | Day 0 | Week 1 | Week 2 | Week 3 | Week 4 |
|---|---|---|---|---|---|
| Orange Oil | 0.342 | 0.335 | 0.38 | 0.41 | 0.42 |
| Spray-dried Orange oil | 0.27 | 0.26 | 0.26 | 0.34 | 0.35 |
| with GLUCIDEX ® 12 | | | | | |
| Spray-dried Orange oil | 0.95 | 0.92 | 1.08 | 1.11 | 1.13 |
| with Lot Exp-01 | | | | | |
| Spray-dried Orange oil | 0.97 | 0.88 | 0.925 | 0.95 | 1.18 |
| with Lot Exp-02 | | | | | |

TABLE 28
Peroxide value

| Sample | Day 0 | Week 1 | Week 2 | Week 3 | Week 4 |
|---|---|---|---|---|---|
| Orange Oil | 2.77 | 5.66 | 7.74 | 12.41 | 10.5 |
| Spray-dried Orange oil | 0.00 | 0.00 | 0.72 | 1.02 | 1.18 |
| with GLUCIDEX ® 12 | | | | | |
| Spray-dried Orange oil | 0.00 | 0.00 | 0.63 | 0.81 | 0.90 |
| with Lot Exp-01 | | | | | |
| Spray-dried Orange oil | 0.00 | 0.00 | 0.61 | 0.66 | 0.85 |
| with Lot Exp-02 | | | | | |

At the one-month point, the C3 accelerated condition showed a slight increase in free fatty acids for all sample. The spray dried samples with soluble starch, much like in the frozen and ambient conditions, showed a higher baseline level of free fatty acids compared to the orange oil and spray dried flavor with GLUCIDEX®12 and the orange oil itself. However, the concentration of Free Fatty Acids remained fairly consistent over the four weeks, showing ~0.20 increase which was similar to the orange oil and only slightly higher than the spray dried sample with GLUCIDEX®12.

For peroxide value, all spray dried samples showed only a slight increase in peroxide value to ~1.0 against the control orange oil which oxidized considerably more. While different compounds can cause noticeable oxidation off-notes at different levels of oxidation, generally a peroxide value <10 is considered not oxidized. At 4 weeks of C3 condition (equivalent to ~4 months ambient condition), the orange oil is considered oxidized which the spray dried flavors with GLUCIDEX®12 and Soluble Starch are considered not oxidized and similarly protective.

Condition C4: 54.4° C. at 60% RH

Free Fatty Acid Concentration

TABLE 29

| Sample | Day 0 | Week 1 | Week 2 | Week 3 | Week 4 |
|---|---|---|---|---|---|
| Orange Oil | 0.342 | 0.385 | 0.4 | 0.435 | 0.44 |
| Spray-dried Orange oil | 0.27 | 0.31 | 0.3 | 0.34 | 0.35 |
| with GLUCIDEX ® 12 | | | | | |
| Spray-dried Orange oil | 0.95 | 0.99 | 1.18 | 1.21 | 1.22 |
| with Lot Exp-01 | | | | | |
| Spray-dried Orange oil | 0.97 | 0.93 | 0.955 | 1.07 | 1.13 |
| with Lot Exp-02 | | | | | |

TABLE 30
Peroxide value

| Sample | Day 0 | Week 1 | Week 2 | Week 3 | Week 4 |
|---|---|---|---|---|---|
| Orange Oil | 2.77 | 7.63 | 9.2 | 13.02 | 8.15 |
| Spray-dried Orange oil | 0.00 | 0.96 | 1.19 | 1.52 | 0.91 |
| with GLUCIDEX ® 12 | | | | | |
| Spray-dried Orange oil | 0.00 | 0.18 | 0.80 | 1.09 | 1.10 |
| with Lot Exp-01 | | | | | |
| Spray-dried Orange oil | 0.00 | 0.16 | 0.72 | 1.02 | 1.00 |
| with Lot Exp-02 | | | | | |

At the one-month point, the C4 was similar to the C3 condition with a slight increase in free fatty acids for all sample. The spray dried samples with soluble starch, much like the other conditions, showed a higher baseline level of free fatty acids compared to the orange oil and spray dried flavor with GLUCIDEX®12 and the orange oil itself. However, the concentration of Free Fatty Acids remained fairly consistent over the four weeks, showing ~0.20-0.3 increase which only slightly higher than the orange oil and spray dried sample with GLUCIDEX®12.

For peroxide value, all spray dried samples showed only a slight increase in peroxide value to ~1.0 against the control orange oil which oxidized considerably more. While different compounds can cause noticeable oxidation off-notes at different levels of oxidation, generally a peroxide value <10 is considered not oxidized. At 4 weeks of C4 condition (equivalent to ~12 months ambient condition), the orange oil is considered oxidized which the spray dried flavors with GLUCIDEX®12 and soluble starch are considered not oxidized and similarly protective.

### CONCLUSION

The Soluble Starch Lots Exp-01 and EXP-02 have similar processability when spray drying compared to the GLUCIDEX®12. The main issue may arise if holding the resulting emulsion for up to 24 hours which shows retrogradation and a notable increase in viscosity in emulsions with the soluble starch compared to a control GLUCIDEX®12. This did not significantly affect the spray drying of the current soluble starch samples.

The resulting emulsions are similar to the GLUCIDEX®12 with the biggest difference being color which will likely be addressed at the industrial production scale with more efficient filtering.

The resulting spray dried orange oil with Soluble starch show similar oil encapsulation efficiency as GLUCIDEX®12 with similar powder characteristics.

At the 1-month point, the oxidative protection of the spray dried soluble starch samples appears to be equivalent to the GLUCIDEX®12 sample.

At one month into the oxidative stability study, the soluble starch samples appear to be an equivalent replacement to 12 DE maltodextrin in the spray drying application.

### Example 3: Preparation of the Soluble Pea Starch with Higher DS and Higher Temperatures

### Material and Equipment

Raw material: Native pea starch N735 (commercialized by the Applicant)
Starch/Jet cooker commercialized by Bottom Line Process Technologies, Inc (referenced as laboratory Starch cooker)
Pressure cooker: Parr pressure reactor 8500
Refining & Spray dryer

### Process, Piloting Procedure and Operating Conditions

Process:

Pea starch and water are mixed in the mixing tank, liquefied by a starch/jet cooker and further thermal treated in a pressure reactor. After cooking, the solution was refined, and then spray dried to form soluble pea starch powder.

Piloting procedure and operating conditions:

The steps of the piloting procedure and related operating conditions are listed below:
Mix 9000 g of pea starch commercialized by the Applicant under the reference N735 with 21,000 g tap water to form 30,000 g starch-water mixture with starch concentration of ~30% by weight,
The mixture was stirred in the mixing tank at room temperature for 15 minutes,
Pump the starch slurry through a starch cooker at 500 g/min flow, with the heating temperature at 140~150° C.
discharge the gelatinized starch slurry to a pressure vessel.
Continue cooking the starch slurry in the pressure vessel until 180° C. and keep there for 10~15 minutes.
Flashing the product to a flashing tank, cool down the cooked solution with cooling coil to 80° C.
Refining the product with 0.1-0.3% active carbon for 45 min and pass a press filter.
Spray dry the solution with the condition of inlet temperature 190° C. and outlet temperature 90° C.

### Sample Analysis

Solubility measurement (MERDGN 1002EN)
Collect 45 ml sample in 50 ml centrifuge tube at room temperature.
Centrifuge the sample at 3000 g for 5 minutes.
Supernatant was collected and weighted.
Dry the supernatant at 130° C. for two hours until constant weighting.
Cool the dried supernatant in desiccator at room temperature for 1 hour.
The solubility was calculated by the question:

$$100 * m * ( M + P ) / ( P 1 * P )$$

where: M=mass of water, P=mass of starch, P1=mass of supernatant,
m=mass of dried residual.
Measurement was repeated twice for accuracy.

### Dextrose Equivalent and Carbohydrate Profile Measurements

Dextrose equivalent (DE) of pilot samples were determined by any method well known in the art. (MERDGN 1005EN)
The carbohydrate profiles were determined by HPLC with double-silver column.

### Viscosity Measurement

Dissolve pilot products in deionized (DI) water at room temperature to form solutions at a concentration of 45% w/w
Viscosity of the solutions was measured with Brookfield II viscometer using #21 spindle, at a temperature of 15° C. following the manufacturer's specifications.
Temperature of the solutions were controlled with circulated water bath.

### Results and Discussion

### Dextrin Equivalent and Carbohydrate Profile

Dextrin equivalent (DE) and carbohydrate profile (DP) are important information about the pilot product properties.

Table 31 is the results of DE and DP measurements of the pilot products, with different batches. DE and DP results of commercial malt dextrin with DE12 (GLUCIDEX® 12 commercialized by the applicant) are also included on the table as comparison.

TABLE 31
Results of DE and DP measurements

| | Pilot batch | | |
|---|---|---|---|
| | Exp-01 | Exp-02 | |
| Properties | 10 min | 12 min | GLUCIDEX ® 12 |
| DE | 9.5 | 12.2 | 10.2 |

Carbohydrate profile (%)

| | | | |
|---|---|---|---|
| Fructose | 0.4 | 0.6 | 0 |
| Glucose | 2.0 | 2.4 | 0.51 |
| Maltose | 2.4 | 2.7 | 2.33 |
| DP3 | 2.9 | 3.0 | 3.83 |
| DP4 | 3.0 | 3.2 | 3.24 |
| DP5 | 3.3 | 3.3 | 3.46 |
| DP6 | 3.5 | 3.3 | 4.36 |
| DP7 | 5.8 | 5.7 | 4.28 |
| DP8-20 | 16.0 | 20.4 | 24.93 |
| DP21+ | 60.2 | 51.5 | 53.1 |
| DP1 + DP2 | 4.8 | 5.7 | 2.84 |

The results indicate that the pilot products have DE values around 11 with the range of 9.5 to 12.2; and have DP1+DP2 concentration around 4-6% (between 4.8 and 5.7%).

The OP distribution of the pilot product is similar to the reference sample.

### Solubility

Another important property parameter is solubility. The soluble starch should have high enough solubility in cold water in order to be used as an alternative of maltodextrin.

### Viscosity

Viscosity directly affects the product applicability and processing-ability; it also reflects the effects of processing conditions on the final products. Currently, viscosity of the commercial DE12 sample is used as reference.

### Comparative Studies

The data are presented in the following Table 32:

| | | | | | α-1,4/ | DP1 and | | |
|---|---|---|---|---|---|---|---|---|
| | Starch | | Viscosity | | α-1,6 | DP2 | DP3 and | |
| Sample | Content | Solubility | (15° C.-45%) | | ratio | content | higher | DE |
| Native pea | >99% | <2% | 20 | cP | 24-31% | 0.0% | / | / |
| starch N735 | | | | | | | | |
| commercialized | | | | | | | | |
| by the Applicant | | | | | | | | |
| Highly Soluble | <10% | >98% | 40-100 | cP | 30-31% | 4-6% | 94-96% | 11 |
| pea starch of the | | | | | | | | |
| present example | | | | | | | | |
| GLUCIDEX ® 12 | ND* | >93% | 300-600 | cP | 22-23% | 3-7% | >90% | 12 |
| commercialized | | | | | | | | |
| by the Applicant | | | | | | | | |

*ND: Not determined, because maltodextrin has no starch content (lodine test not blue)

It is clear here too that the highly soluble pea starch of the invention is functionally a maltodextrin and structurally a starch.

1. A highly soluble leguminous starch having:
A content of oligosaccharides with a Degree of Polymerization (DP) of 1 and 2 of less than 10% in weight, preferably of less than 7% in weight,
A content of oligosaccharides with a DP of 3 to 20 of between 30% and 40% in weight,
A water solubility of more than 95% in weight, more preferably more than 98% in weight,
A viscosity of less than 500 cP, more preferably of less than 200 cP
and characterized by:
An α-1,4/α-1,6 ratio determined by ¹³C NMR between 23 to 32%.

2. The highly soluble starch according to claim 1, wherein the starch is pea or faba bean starch.

3. A method of preparation of a highly soluble starch, said method comprising the steps of:
Preparation of a starch slurry,
Gelatinization of the starch slurry,
Cooking of the gelatinized starch,
Refining of the thermally decomposed solution such obtained with active carbon, filtration and evaporation, and
drying of the concentrated solution to obtain a powder product.

4. The method according to claim 3, wherein the starch is a native leguminous starch.

5. The method according to claim 4, wherein the starch is pea or faba bean starch.

6. The method according to claim 3, wherein the starch slurry is prepared by adding starch powder form in water to reach an initial starch-water mixture, wherein the starch in the initial starch-water mixture represents 10 to 35% by weight with respect to the total weight of the starch-water mixture, more preferably 15 to 30%.

7. The method according to claim 3, wherein the gelatinization is performed by steam cooking, jet-cooker cooking, cooking on a drum, cooking in kneader/extruder systems followed by drying for example in an oven, by hot air on a fluidized bed, on rotating drum, by atomization, by extrusion or by lyophilization.

8. The method according to claim 3, wherein the gelatinization of the starch is performed continuously in a jet cooker at a temperature between 14° and 150° C.

9. The method according to claim 3, wherein the cooking of the gelatinized starch is performed at a temperature up to 175° C., at a pressure between 1.43 to 12.55 bar, more preferably at a pressure between 4.16 to 8.94 bar.

10. The method according to claim 3, wherein the cooking of the gelatinized starch is performed at a temperature up to 180° C., at a pressure between 9 to 9.5 bar.

11. The method according to claim 3, wherein the cooked solution is refined with active carbon, filtrated and evaporated, and dried into powder form using dryer such as drum dryer, flash dryer, spray dryer, freeze dryer.

12. The method according to claim 11, wherein the cooked solution is dried into powder form using a spray dryer, the inlet temperature in the spray dryer being between 150 to 250° C., more preferably between 170 to 190° C.; and the outlet temperature being between 60 to 120° C., more preferably between 80 to 90° C.

13. Use of the highly soluble leguminous starch of claim 1 in food applications as an alternative to maltodextrin.

14. Use of the highly soluble leguminous starch of claim 1 as an alternative to maltodextrin for the preparation of bakery, sauce and dressing, dairy and beverage, more specifically as carrier for flavor encapsulation, for the formulation of fat free vinaigrette and for the preparation of powder beverage formulations.

15. The method according to claim 4, wherein the starch slurry is prepared by adding starch powder form in water to reach an initial starch-water mixture, wherein the starch in the initial starch-water mixture represents 10 to 35% by weight with respect to the total weight of the starch-water mixture, more preferably 15 to 30%.

16. The method according to claim 5, wherein the starch slurry is prepared by adding starch powder form in water to reach an initial starch-water mixture, wherein the starch in the initial starch-water mixture represents 10 to 35% by weight with respect to the total weight of the starch-water mixture, more preferably 15 to 30%.

17. The method according to claim 4, wherein the gelatinization is performed by steam cooking, jet-cooker cooking, cooking on a drum, cooking in kneader/extruder systems followed by drying for example in an oven, by hot air on a fluidized bed, on rotating drum, by atomization, by extrusion or by lyophilization.

18. The method according to claim 5, wherein the gelatinization is performed by steam cooking, jet-cooker cooking, cooking on a drum, cooking in kneader/extruder systems followed by drying for example in an oven, by hot air on a fluidized bed, on rotating drum, by atomization, by extrusion or by lyophilization.

19. The method according to claim 6, wherein the gelatinization is performed by steam cooking, jet-cooker cooking, cooking on a drum, cooking in kneader/extruder systems followed by drying for example in an oven, by hot air on a fluidized bed, on rotating drum, by atomization, by extrusion or by lyophilization.

20. Use of the highly soluble leguminous starch of claim 2 in food applications as an alternative to maltodextrin.
